(19) United States
(12) Patent Application Publication
(10) Pub. No.: US 2007/0075146 A1
(43) Pub. Date: Apr. 5, 2007

(54) Portable data processing device having laser light indicator

(76) Inventor: Shih-An Yang, Taipei City (TW)

Correspondence Address: HARNESS, DICKEY & PIERCE, P.L.C., P.O. BOX 8910, RESTON, VA, 20195, US

(21) Appl. No.: 11/240,376

(22) Filed: Oct. 3, 2005

(51) Int. Cl. G06K 19/06

(52) U.S. Cl. 235/492

(57) ABSTRACT

A portable data processing device having a laser light indicator includes a main body and a cover cap. The main body has an application circuit unit and one end of the main body has a signal transmission port connected to the application circuit unit. The cover cap can be sleeved onto the main body, and is used to shield and protect the signal transmission port, and is composed of a hollow tube and a rotation cap body. The hollow tube has an opening, and the rotation cap body is assembled and connected to the opening to form an enclosed reception space; a laser light indicator, disposed inside the reception space, and is provided with a power storage unit and a control button. When the control button is pressed, the power provided by the power storage unit is transmitted to the laser light indicator for emitting light.

### BACKGROUND

1. Field of the Invention

The present invention relates to a data processing device. More particularly, the present invention relates to a portable data processing device having a laser light indicator.

2. Related Art

With the rapid progress and development of science and technology, the functions of electronic devices are ever more multiplied and diversified, and their data storage and processing capacities have increased tremendously. In addition, the sizes of these electronic devices have decreased steadily, and their prices have been also significantly reduced.

Nowadays, a variety of electronic devices are designed and developed to meet the requirements of our daily lives, such as the desktop computer utilized for business operations or personal recreation and entertainment, notebook computers, personal data assistants (PDA), mobile phones, smart phones, etc, utilized for easy carriage and operation.

Likewise, the volume of data processing incurred by the software used in the operation of these electronic devices also increases enormously. As such, the data storage capacity of a floppy diskette is no longer sufficient to use.

Though a compact disk, having a large data storage capacity, has subsequently been developed and introduced into the market, yet it is still subject to the shortcomings and disadvantages of being read only but not re-writeable.

As such, a special kind of electronic device called ‘portable disk’, presently available on the market, can be utilized to solve the above-mentioned problem.

The size of the portable disk is small and thus easy to carry and operate, and it is provided with a rewritable large capacity memory. Therefore, it can be plugged in and connected to an electronic device, such as a notebook computer or desktop computer to conduct data transmission. The price of such a portable disk is pretty high in early and thus can not be popularized, yet its price is now much cheaper due to the progress and improvement of the semiconductor manufacturing process. As such this kind of electronic device has become the standard gadget of businessmen and ordinary people.

In the prior art, the various portable disk manufacturing technologies are disclosed in the following Patents: U.S. Pat. No. 6,522,534 (hereinafter referred to as case 534), U.S. Pat. No. 6,744,634 (hereinafter referred to as case 634), U.S. Pat. No. 6,733,329 (hereinafter referred to as case 329), and U.S. Pat. No. 6,763,410 (hereinafter referred to as case 410), and these documents are all incorporated herein for reference.

In case 534 is disclosed a pen-cap like mask body, which can be capped onto one end of a portable disk. When the mask body is put on the portable disk, the terminal on the portable disk can thus be shielded and protected. Similar designs are disclosed in case 634 and case 410. In case 410, the design of the mask body is further varied. For example, a connection piece is utilized to connect the mask body and the portable disk, so that when the mask body is detached from the portable disk, it is still connected to one side of the portable disk through the connection piece. In case 329, a similar mask body is utilized to protect the terminal portion, in addition, the terminal portion may be freely detached and replaced, as such, it is suitable to use for the connection ports of various types and specifications.

However, for the portable disks currently available on the market or disclosed in the afore-mentioned Patents, it is evident that the protection of the terminal portion is the only function provided by the mask body of the portable disk. In R.O.C. patent publication No. 499087, the patent is disclosed a portable storage device with a laser pointer for presentation, wherein a laser diode is provided in a mask body, so that the user may press the switch to turn on the laser diode, to emit light. Though such an idea is proposed in this patent case, however, upon perusal of its contents, it is found that the battery required for power supply and the related electronic components required for its operation are not disclosed in the specification, and thus, in practice, its implementation is almost out of the question..

### SUMMARY

In view of the above-mentioned problems and shortcomings of the prior art, the object of the invention is to provide a portable data processing device with a laser light indicator, having the fully equipped electronic components, to be able to function normally.

Therefore, to achieve the above-mentioned objective, the invention provides a portable data processing device having a laser light indicator, including a main body, which is provided with an application circuit unit. One end of the main body is provided with a signal transmission port connected to the application circuit unit, as such providing data transmission capability to / from the outside computer equipment. A. cover cap can be detached separately and sleeved onto the main body, thus shielding and protecting the signal transmission port. Moreover, the cover cap is composed of a hollow tube and a rotation cap body. One end of the hollow tube is provided with an opening, and the rotation cap body can be assembled and connected to the opening to form an enclosed reception space. The laser light indicator is disposed in the reception space, and is provided with a power storage unit and a control button on the cover cap, so that when the control button is pressed, the power storage unit is utilized to transmit the power required to the laser light indicator, to generate and emit light.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and thus are not limitative of the present invention, and wherein:

FIG. 1 is a schematic view of a portable data processing device having a laser light indicator of the invention;

FIG. 2 is an enlarged view of the laser light indicator and cover cap of a portable data processing device, shown as a portion of FIG. 1 according to an embodiment of the invention; and

FIG. 3 is a schematic view of a portable data processing device having a laser light indicator being used according to an embodiment of the invention.

### DETAILED DESCRIPTION

The purpose, construction, features, and functions of the invention can be appreciated and understood more thoroughly through the following detailed description with reference to the attached drawings.

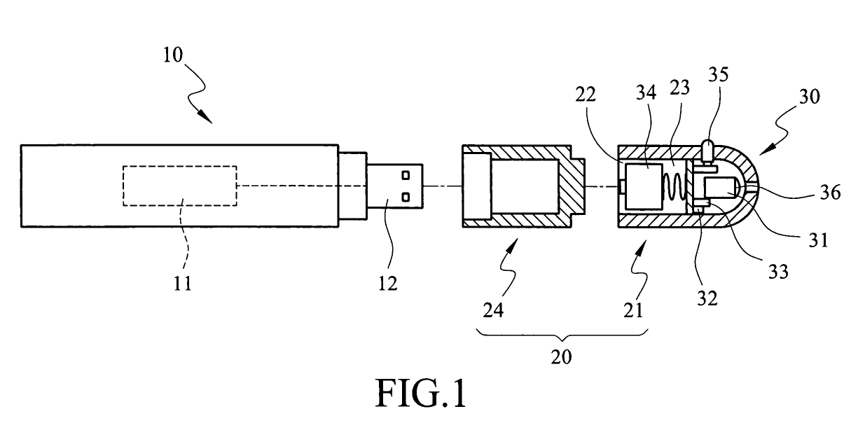

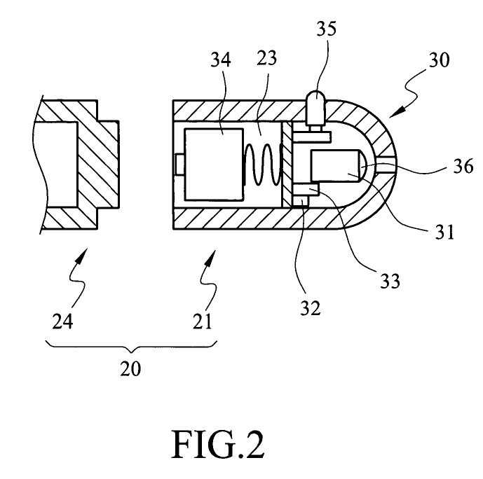

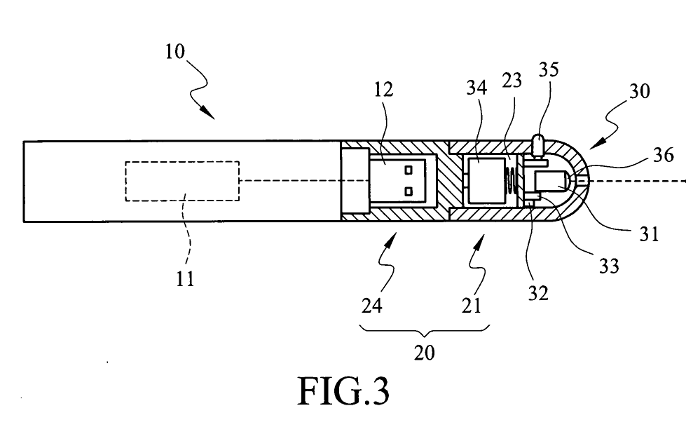

In the following discussions, refer to FIGS. 1 to 3 for a detailed description of the composition elements and their relative arrangement of the portable data processing device having the laser light indicator of the invention.

The portable data processing device of the invention includes a main body 10, a cover cap 20 and a laser light indicator 30. The main body 10 is provided with an application circuit unit 11. One end of the main body 10 is provided with a signal transmission port 12 connected to the application circuit unit 11. The varieties and specifications of signal transmission ports 12 are enormous, such as the Universal Serial Bus (USB) as shown in FIGS. 1 to 3.

In the above description, the application circuit unit 11 may be a memory unit, a wireless signal transceiver (for example, capable of communication in compliance with the Bluetooth communication protocol), an image fetching module (for example a camera), a mobile phone communication module, an audio broadcasting module (for example an MPEG Layer-3 player), or a memory card reader connected to the outside memory card and capable of reading the data stored therein. The application circuit unit 11 can be realized in various configurations, and its varieties and specifications are enormous. The development of such electronic components has reached a rather mature level, so that the people familiar with the technology of this field may select the components at their own choice depending on the actual requirements. Since such electronic components are not the essence of the invention, they will not be discussed in detail here for brevity's sake. In addition, depending on the type utilized, the batteries may be disposed in cooperation with the application circuit unit 11 to provide the power required.

The cover cap 20 can be sleeved onto the main body 10 to shield and protect the signal transmission port 12 and prevent it from the entering of foreign objects such as dust, since that would incur data reading error. The cap cover 20 can be detached separately from the main body 10, so that the signal transmission port 12 is again exposed and able to connected electrically to an outside computer (not shown in the FIGS.) to proceed with data transmission. The cap cover 20 is composed of a hollow tube 21 and a rotation cap body 24. One side of the hollow tube 21 is provided with an opening 22, and the rotation cap body 24 can be assembled and connected to the opening 22 to form an enclosed reception space 23. A laser light indicator 30 is installed in the reception space 23, and includes a laser diode 31, a power storage unit 34, and a control button 35 protruding out from the cap cover 20. The laser light indicator 30 further includes an optical lens 36 disposed in front of the laser diode 31 to control the angle and direction of the emitting light. In addition, the laser light indicator 30 is provided with a voltage-current conversion circuit unit 32 and a voltage stabilization circuit unit 33. The voltage-current conversion circuit unit 32 is utilized to convert the power supplied by the power storage unit 34, so that its voltage and current ratings are compatible with the specifications of the laser diode 31. Similarly, the voltage stabilization circuit unit 33 is used to stabilize the voltage of the power supplied by the power storage unit 34 within a predetermined voltage range, and thus provide it for the laser diode 31. When the control button 35 is pressed, the power storage unit 34 is utilized to provide the operation power, required for the laser diode 31 of the laser light indicator 30, so that light is generated and then emitted through the optical lens 36. Upon using up all the power stored in the power storage unit 34, press and rotate the rotation cap body 24 to detach it from the hollow tube 21, so that the power storage unit 34 can be taken out and replaced. As such, the power storage unit 34 may be a rechargeable battery or a disposable primary battery. In addition, a metal spring or metal elastic plate is used as the contact between the power storage unit 34 and laser light indicator 30, to facilitate the transfer of power from the power storage unit 34 to the laser light indicator 30. Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable data processing device having laser light indicator, comprising:
a main body provided with an application circuit unit inside, one end of the main body having provided with a signal transmission port connected with the application circuit unit, so as to transmit/receive data to/ from an outside computer;
a cover cap, detached separately and sleeved onto one end of the main body to shield and protect the signal transmission port, the cover cap including a hollow tube and a rotation cap body, one side of the hollow tube having provided with an opening, the rotation cap body being assembled and connected to the opening to form an enclosed reception space; and
a laser light indicator, provided inside the reception space, including a power storage unit, and a control button, so that when the control button being pressed, the power storage unit being utilized to provide power to the laser light indicator, so as to generate and emit light.

2. The portable data processing device having laser light indicator of claim 1, wherein the application circuit unit is a memory unit.

3. The portable data processing device having laser light indicator of claim 1, wherein the application circuit unit is a wireless signal transceiver.

4. The portable data processing device having laser light indicator of claim 1, wherein the application circuit unit is an image fetching module.

5. The portable data processing device having laser light indicator of claim 1, wherein the application circuit unit is a mobile phone communication module.

6. The portable data processing device having laser light indicator of claim 1, wherein the application circuit unit is an audio broadcasting module.

7. The portable data processing device having laser light indicator of claim 1, wherein the application circuit unit is a data access unit, which can be connected to an outside memory card to read the data stored therein.

8. The portable data processing device having laser light indicator of claim 1, wherein the light emitted by the laser light indicator is generated by a laser diode.

9. The portable data processing device having laser light indicator of claim 8, wherein the laser light indicator includes an optical lens, disposed in front of the laser diode.

10. The portable data processing device having laser light indicator of claim 1, wherein the laser light indicator includes a voltage-current-conversion circuit unit, which is used to convert the voltage and current ratings of the power supplied by the power storage unit.

11. The portable data processing device having laser light indicator of claim 1, wherein the laser light indicator includes a voltage stabilization circuit unit, which is used to keep the voltage rating of the power provided by the power storage unit at a predetermined value.

12. The portable data processing device having laser light indicator of claim 1, wherein the power storage unit is a rechargeable battery.

13. The portable data processing device having laser light indicator of claim 1, wherein the power storage unit is a primary battery.

14. The portable data processing device having laser light indicator of claim 1, wherein a metal elastic plate is disposed between the laser light indicator and the power storage unit.

15. The portable data processing device having laser light indicator of claim 1, wherein a metal spring is disposed between the laser light indicator and the power storage unit.
